(19) United States
(12) Patent Application Publication
(10) Pub. No.: US 2011/0019191 A1
(43) Pub. Date: Jan. 27, 2011

(54) Display Inspection Tool, Display Inspection Module, and Display Inspecting Method

(76) Inventors: Chih-Hua Hsu, Taipei Hsien (TW); Jung-Shiung Liau, Taipei Hsien (TW); Gustavo Salazar, Taipei Hsien (TW)

Correspondence Address: Hollingsworth & Funk, 8500 Normandale Lake Blvd., Suite 320, Minneapolis, MN, 55437, US

(21) Appl. No.: 12/841,339

(22) Filed: Jul. 22, 2010

(30) Foreign Application Priority Data
Jul. 24, 2009 (TW) 098125035

(51) Int. Cl. G01J 3/46; G01N 21/01

(52) U.S. Cl. 356/402; 356/244

(57) ABSTRACT

A display inspection tool includes a securing member and a color detector securing unit. The securing member includes a top edge securing portion that is adapted for disposing on a top edge of a display, and a bottom edge securing portion that is adapted for abutting against a bottom edge of the display. By disposing the top edge securing portion on the top edge of the display, and bringing the bottom edge securing portion into abutment against the bottom edge of the display, the securing member can be quickly mounted on the display. The color detector securing unit is provided on a rear face of the securing member and is adapted for securing a color detector so as to perform color detection when the securing member is mounted on the display.

### CROSS-REFERENCE TO RELATED APPLICATION

This application claims priority of Taiwanese application no. 098125035, filed on Jul. 24, 2009.

### BACKGROUND OF THE INVENTION

1. Field of the Invention

This invention relates to a display inspection tool, more particularly to display inspection tool adapted for positioning a color detector relative to a display.

2. Description of the Related Art

In general, a color analyzer is used for measuring brightness and color coordinates of a display panel of a display. The color analyzer includes a detecting gun that faces a geometric center of the display panel of the display when color analysis is performed.

Referring to FIG. 1, ROC Utility Model Publication Number 376989 discloses a display inspection facilitating tool 9 for positioning a detecting gun 900 relative to a display panel 902 of a display 901. The display inspection facilitating tool 9 includes a sleeve tube 91, and a plurality of arms 92 extending transversely from an end of the sleeve tube 91 along four directions of a cross. The sleeve tube 91 provides an accommodating space for receiving the detecting gun 900 such that a front end of the detecting gun 900 faces the display panel 902 of the display 901. Each of the arms 92 is formed with a slide groove 921, and includes a first tumbler pin 93 that is slidable in the slide groove 921 for abutting against a front side of the display 901 so as to adjust a distance between the detecting gun 900 and the display panel 902, and a second tumbler pin 94 that is slidable in the slide groove 921 for abutting against an outer edge of the display 901 so as to dispose the display inspection facilitating tool 9 on the display 901.

Since adjustment of the first and second tumbler pins 93,94 for mounting the display inspection facilitating tool 9 on the display 901 requires labor time, production efficiency is reduced.

ROC Patent Publication Number 200907326 also discloses a device with another type of structure.

### SUMMARY OF THE INVENTION

Therefore, an object of the present invention is to provide a display inspection tool that has a simple structure, and that can be quickly mounted on a display.

Another object of the present invention is to provide a display inspection module that includes the foregoing display inspection tool.

Accordingly, there is provided a display inspection tool adapted for positioning a color detector relative to a display the color detector having a lens end. The display inspection tool comprises a securing member and a color detector securing unit.

The securing member is adapted for mounting on the display, and includes a securing body, a top edge securing portion, and a bottom edge securing portion. The securing body has a front face for facing a display panel of the display, and a rear face, and is formed with a central through hole extending in a front-rear direction. The top edge securing portion is disposed on the securing body, extends forwards from the securing body, and is adapted for disposing on a top edge of the display. The bottom edge securing portion is disposed on the securing body below the top edge securing portion, extends forwards from the securing body, and is adapted for abutting against a bottom edge of the display.

The color detector securing unit includes a plurality of guiding elements and a securing seat. The guiding elements are spaced apart from one another, are disposed on the rear face of the securing body adjacent to the central through hole, and extend rearwards from the securing body. The securing seat is disposed on the guiding elements such that the securing seat is movable forward, toward the securing body, and rearward, away from the securing body, and is adapted for securing the color detector such that the lens end of the color detector faces the central through hole.

The display inspection tool of the present invention has a simple structure that can be easily manufactured at a low cost and can be quickly mounted on a display, thus saving time.

### BRIEF DESCRIPTION OF THE DRAWINGS

Other features and advantages of the present invention will become apparent in the following detailed description of the preferred embodiment with reference to the accompanying drawings, of which:

FIG. 1 is a perspective view of a conventional display inspection facilitating tool disclosed in ROC Utility Model Publication Number 376989;

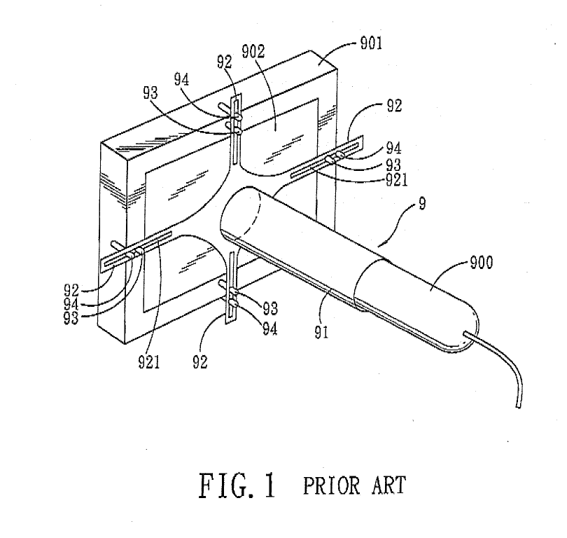

FIG. 2 is a rear perspective view of a preferred embodiment of a display inspection tool according to the present invention;

FIG. 3 is an exploded perspective view of the preferred embodiment for illustrating a color detector separated from a securing member of the preferred embodiment;

FIG. 4 is a front perspective view of the preferred embodiment;

FIG. 5 is a flowchart of a preferred embodiment of a display inspecting method according to the present invention;

FIG. 6 is a front view of the preferred embodiment of the display inspection tool when the display inspection tool is mounted on a display;

FIG. 7 is a rear view of the preferred embodiment of the display inspection tool when the display inspection tool is mounted on the display;

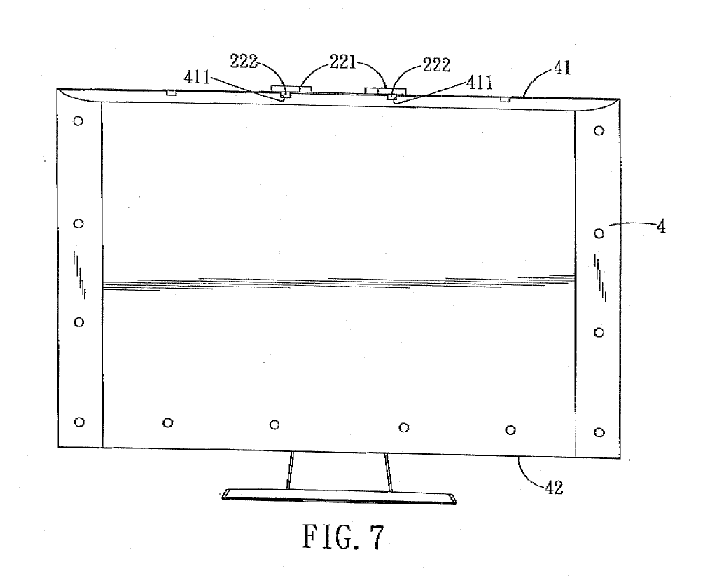

FIG. 8 is a lateral view of the preferred embodiment of the display inspection tool when the display inspection tool is mounted on the display; and

FIG. 9 is a lateral view of a preferred embodiment of a display inspection module according to the present invention.

### DETAILED DESCRIPTION OF THE PREFERRED EMBODIMENT

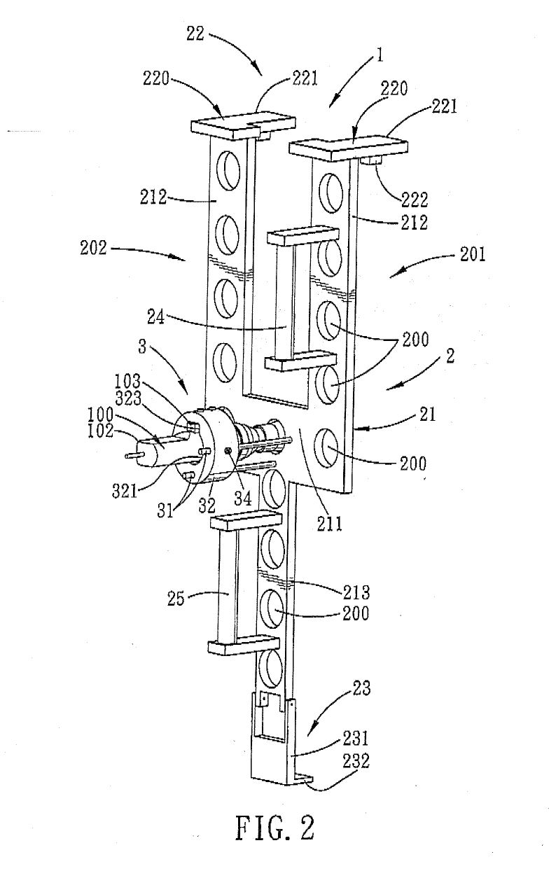

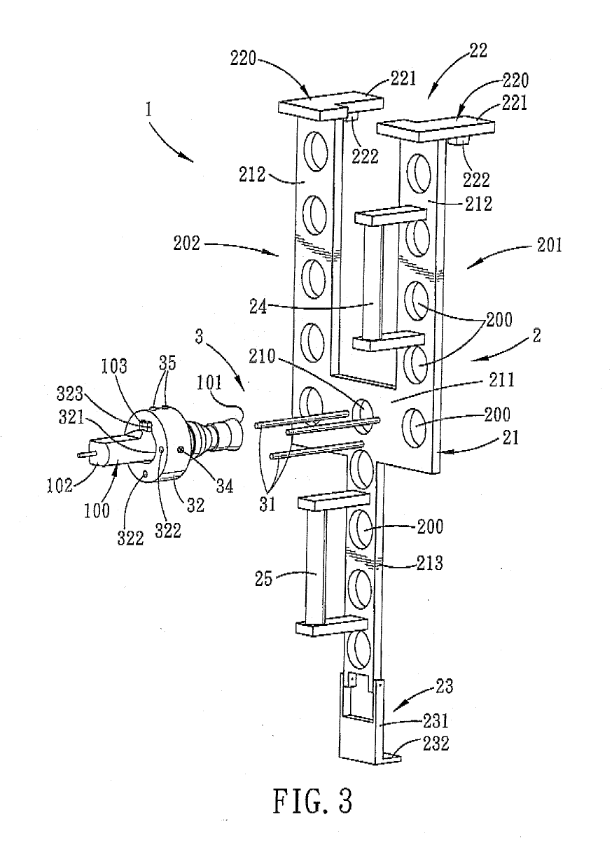

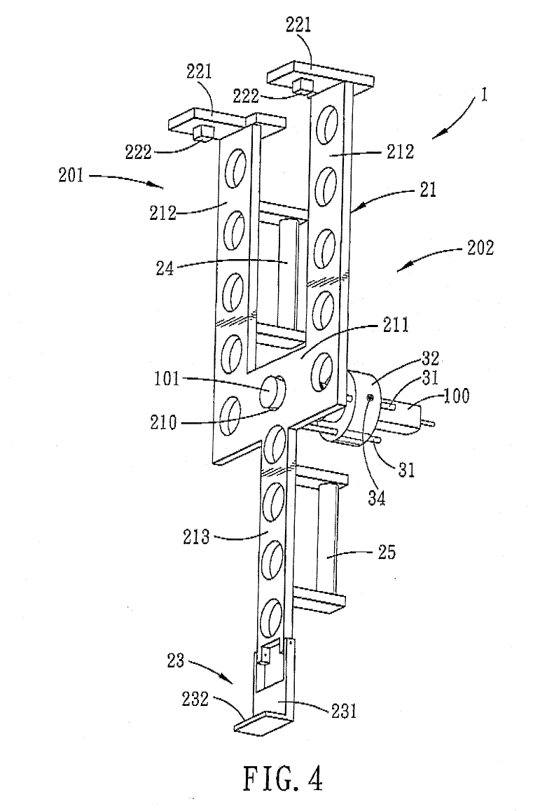

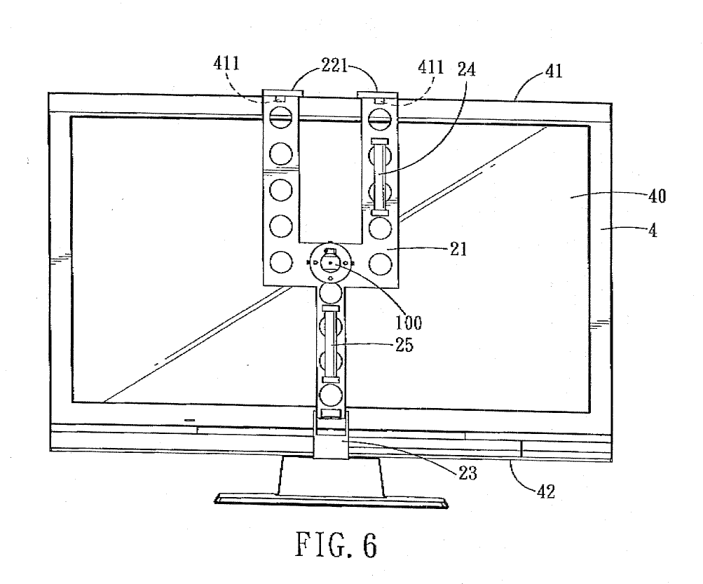

FIGS. 2 to 4 illustrate the preferred embodiment of a display inspection tool 1 according to the present invention. The display inspection tool 1 is adapted for positioning a color detector 100 relative to a display 4 (see FIG. 6). The color detector 100 is used to detect brightness and color coordinates of the display 4, and has a lens end 101. In this embodiment, the color detector 100 is a detecting gun of a color analyzer, and includes a gun body 102 and a positioning piece 103 for positioning the gun body 102. Referring to FIG. 6, the display 4 has a top edge 41 formed with a pair of spaced apart notches 411 that are disposed respectively on opposite sides of and at equal distances from a geometric center of a display panel 90 of the display 4. Such notches 411 are typically formed in the display 4 for fastening an outer casing of the display 4.

The display inspection tool 1 includes a securing member 2 and a color detector securing unit 3. The securing member 2 is adapted for mounting on the display 4, and includes a securing body 21, a top edge securing portion 22 and a bottom edge securing portion 23.

The securing body 21 has a front face 201 for facing the display panel 40 of the display 4, and a rear face 202, and is formed with a central through hole 210 extending in a front-rear direction. The top edge securing portion 22 is disposed on the securing body 21, extends forwards from the securing body 21, and is adapted for disposing on the top edge 41 of the display 4. The bottom edge securing portion 23 is disposed on the securing body 21 below the top edge securing portion 22, extends forwards from the securing body 21, and is adapted fox abutting against a bottom edge 42 (see FIG. 6) of the display 4.

In this embodiment, the securing body 21 is substantially Y-shaped, and includes a horizontally extending connecting section 211, a pair of upper arm sections 212 extending upwards from the connecting section 211 and spaced apart from each other, a lower arm section 213 extending downwards from the connecting section 211, and first and second handles 24,25. The connecting section 211 is formed with the central through hole 210. The first handle 24 is coupled to a rear face of one of the upper arm sections 212, and the second handle 25 is coupled to a rear face of the lower arm section 213. The first and second handles 24, 25 are used to facilitate moving the display inspection tool 1. Moreover, in this embodiment, the connecting section 211, the upper arm sections 212 and the lower arm section 213 are formed with a plurality of apertures 200 for reducing a weight of the securing body 21.

In this embodiment, the top edge securing portion 22 includes a pair of seat parts 220 disposed respectively on top ends of the upper arm sections 212. Each of the seat parts 220 includes a seat plate 221 extending forwards from the top end of the respective one of the upper arm sections 212, and a positioning block 222 disposed on a bottom face of the seat plate 221 and in front of the securing body 21. The positioning blocks 222 of the seat parts 220 are extendible into the notches 411 in the top edge 41 of the display 4, respectively.

In this embodiment, the bottom edge securing portion 23 is disposed on a bottom end of the lower arm section 213, has a generally L-shaped lateral cross section, and includes a first plate section 231 that extends in a top-bottom direction, and a second plate section 232 that extends forwards from a bottom end of the first plate section 231. The first plate section 231 has a pivot point on a top end thereof that is coupled to the bottom end of the lower arm section 213. The second plate section 232 abuts against the bottom edge 42 of the display 4 when the securing member 2 is mounted on the display 4, as best shown in FIG. 6.

The color detector securing unit 3 includes a plurality of guiding elements 31 and a securing seat 32. The guiding elements 31 are spaced apart from one another, are disposed on the rear face 202 of the securing body 21 adjacent to the central through hole 210, and extend rearwards from the securing body 21. The securing seat 32 is disposed on the guiding elements 31 such that the securing seat 32 is movable forward, toward the securing body 21, and rearward, away from the securing body 21, and is adapted for securing the color detector 100 such that the lens end 101 of the color detector 100 faces the central through hole 210.

In this embodiment, each of the guiding elements 31 of the color detector securing unit 3 is an elongate rod. The securing seat 32 has a ring shape, defines a central ring opening 321 through which the color detector 100 is to be extended, and is formed with a plurality of through holes 322 extending in the front-rear direction and through which the guiding elements 31 respectively extend so that the securing seat 32 is movable along the guiding elements 31. Preferably, the securing seat 32 further has an inner wall surface formed with a groove 323. Moreover, in this embodiment, the color detector securing unit 3 further includes a plurality of first adjusting screws 34 and a plurality of second adjusting screws 35. The first adjusting screws 34 extend threadedly through the securing seat 32 for abutting against the guiding elements 31, thereby limiting movement of the securing seat 32 along the guiding elements 31. The second adjusting screws 35 extend threadedly through the securing seat 32 for abutting against the color detector 100 so as to secure the color detector 100 in the securing seat 32.

In use, the gun body 102 of the color detector 100 is extended through the central ring opening 321 such that the lens end 101 faces the central through hole 210, and the positioning piece 103 of the color detector 100 is received in the groove 323 of the securing seat 32. The second adjusting screws 35 are then extended threadedly through the securing seat 32 for securing the color detector 100 in the securing seat 32. Lastly, after extending the guiding elements 31 through the through holes 322 and moving the securing seat 32 to a desired position on the guiding elements 31, the first adjusting screws 34 are extended threadedly through the securing seat 32 for limiting movement of the securing seat 32 along the guiding elements 31.

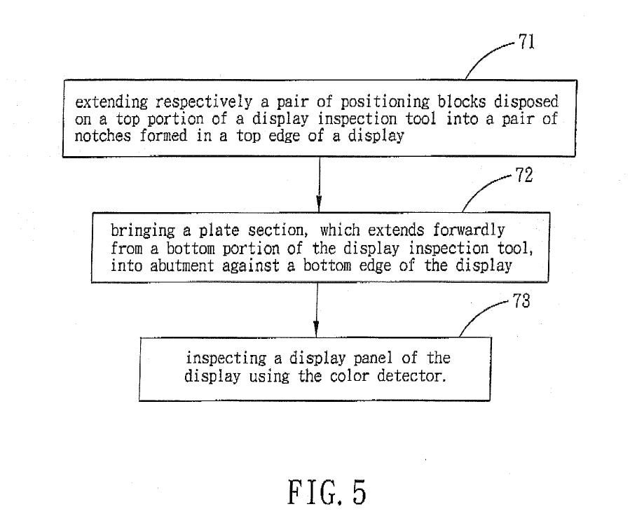

Referring to FIG. 5, the display inspecting method according to the present invention is performed using the display inspection tool 1 having the color detector 100 secured thereon. The display inspecting method includes the following steps.

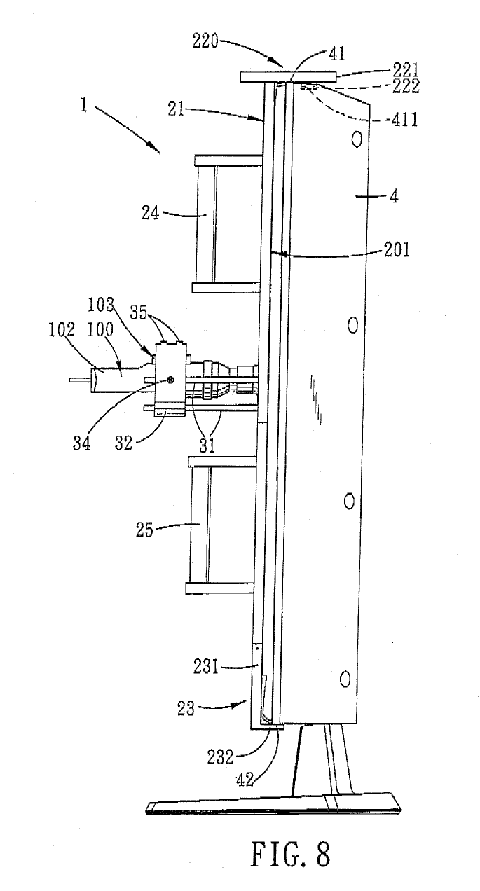

In step 71, the positioning blocks 222 of the top edge securing portion 22 of the display inspecting tool 1 are extended respectively into the pair of notches 411 in the top edge 41 of the display 4 so that the front face 201 of the securing body 21 faces the display panel 40 of the display 4, as shown in FIGS. 6 and 8.

In step 72, the second plate section 232 of the bottom edge securing portion 23 of the display inspecting tool 1 is brought into abutment against the bottom edge 42 of the display 4. It is noted that in this embodiment, the display inspection tool 1 is configured such that after the second plate section 232 is brought into abutment against the bottom edge 42 of the display 4, the central through hole 210 of the securing body 21 is registered with the geometric center of the display panel 40 of the display 4, and as such, the lens end 101 of the gun body 102 of the color detector 100 is also registered with the geometric center of the display panel 40 of the display 4.

In step 73, the display panel 40 of the display 4 is inspected using the color detector 100. It is noted that in this embodiment, the securing seat 32 can be repositioned along the guiding elements 31 through adjusting the first adjusting screws 34, thereby adjusting a distance between the lens end 101 of the gun body 102 of the color detector 100 and the display panel 40 of the display 4.

From the foregoing description, it is clear that the securing member 2 of this embodiment is structurally simple, and mounting the securing member 2 on the display 4 only requires extending the positioning blocks 222 respectively into the notches 411 in the top edge 41 of the display 4, and bringing the second plate section 232 of the bottom edge securing portion 23 into abutment against the bottom edge 42 of the display 4. The simplicity of these steps saves time, and thus increases manufacturing efficiency.

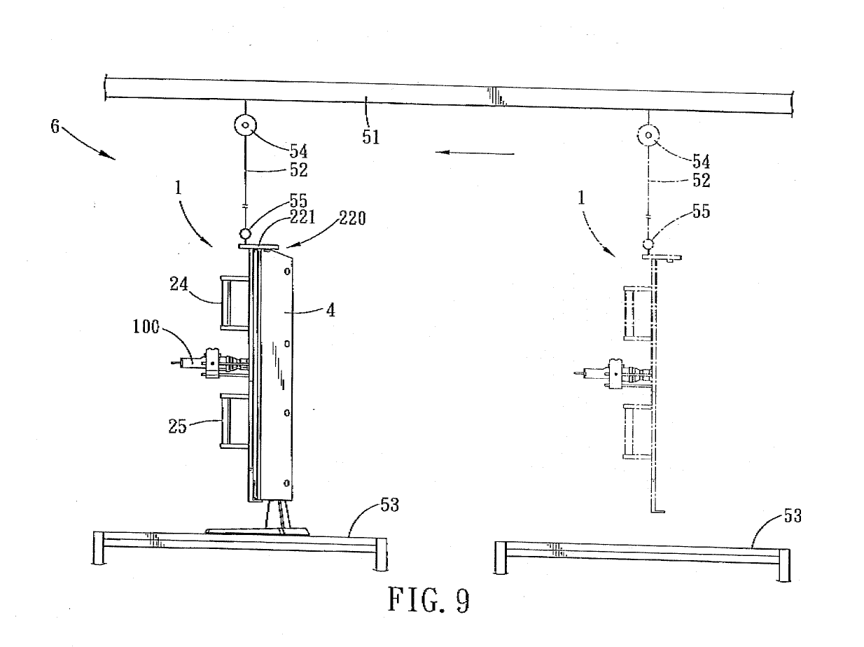

Referring to FIG. 9, the display inspection tool 1 can be incorporated in a display inspecting module 6 so as to be used in an assembly line having a plurality of workstations 53. The display inspecting module 6 includes a pair of guiding rails 51 and a pair of suspending cables 52. The suspending cables 52 (due to the viewing angle, only one is shown in the Figure) have top ends coupled respectively to the guiding rails 51 (due to the viewing angle, only one is shown in the Figure) by a pair of sliding elements 54, respectively, and bottom ends that are connected respectively to the seat parts 220 of the securing member 2. Preferably, each of the seat plates 221 of the seat parts 220 includes a suspending ring 55 for coupling the bottom end of the corresponding suspending cable 52 to the seat part 220 such that the display inspection tool 1 is suspended for moving among the workstations 53.

In summary, the display inspection tool 1 of the present invention not only has a simple structure that can be easily manufactured at a low cost, but also can be quickly mounted on the display 4 using the notches 411 in the display 4, thus saving time.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A display inspection tool adapted for positioning a color detector relative to a display, the color detector having a lens end, said display inspection tool comprising:
a securing member adapted for mounting on the display, and including
a securing body having a front face for facing a display panel of the display, and a rear face, said securing body being formed with a central through hole extending in a front-rear direction,
a top edge securing portion disposed on said securing body and extending forwards from said securing body, said top edge securing portion being adapted for disposing on a top edge of the display, and
a bottom edge securing portion disposed on said securing body below said top edge securing portion and extending forwards from said securing body, said bottom edge securing portion being adapted for abutting against a bottom edge of the display; and
a color detector securing unit including
a plurality of guiding elements spaced apart from one another, disposed on said rear face of said securing body adjacent to said central through hole, and extending rearwards from said securing body, and
a securing seat disposed on said guiding elements such that said securing seat is movable forward, toward said securing body, and rearward, away from said securing body, said securing seat being adapted for securing the color detector such that the lens end of the color detector faces said central through hole.

2. The display inspection tool as claimed in claim 1, wherein:
said securing body includes a connecting section, a pair of upper arm sections extending upwards from said connecting section and spaced apart from each other, and a lower arm section extending downwards from said connecting section;
said top edge securing portion includes a pair of seat parts, said seat parts being disposed respectively on top ends of said upper arm sections; and
said bottom edge securing portion is disposed on a bottom end of said lower arm section.

3. The display inspection tool as claimed in claim 2, the top edge of the display being formed with a pair of notches that are spaced apart from each other, wherein each of said seat parts includes a seat plate extending forwards from said top end of the respective one of said upper arm sections, and a positioning block disposed on a bottom face of said seat plate, said positioning blocks of said seat parts being extendible into the notches in the top edge of the display, respectively.

4. The display inspection tool as claimed in claim 3, wherein said bottom edge securing portion has a generally L-shaped lateral cross section, and includes a first plate section that extends in a top-bottom direction and a second plate section that extends forwards from a bottom end of said first plate section, said first plate section having a top end coupled pivotably to said bottom end of said lower arm section, said second plate section abutting against the bottom edge of the display when said securing member is mounted on the display.

5. The display inspection tool as claimed in claim 4, wherein:
each of said guiding elements is an elongate rod;
said securing seat has a ring shape, defines a central ring opening through which the color detector is to be extended, and is formed with a plurality of through holes extending in the front-rear direction and through which said guiding elements respectively extend so that said securing seat is movable forward, toward said securing body, and rearward, away from said securing body, along said guiding elements; and
said color detector securing unit further includes a plurality of first adjusting screws extending threadedly through said securing seat for abutting against said guiding elements, thereby limiting movement of said securing seat along said guiding elements.

6. The display inspection tool as claimed in claim 5, wherein said color detector securing unit further includes a plurality of second adjusting screws extending threadedly through said securing seat for abutting against the color detector so as to secure the color detector in said securing seat.

7. A display inspection module comprising:
a guiding rail set including a guiding rail;
a suspending cable set including a suspending cable that has a top end coupled to said guiding rail of said guiding rail set; and
a display inspection tool adapted for positioning a color detector relative to a display, the color detector having a lens end, said display inspection tool including:
a securing member adapted for mounting on the display, and including
a securing body having a front face for facing a display panel of the display, and a rear face, said securing body being formed with a central through hole extending in a front-rear direction,
a top edge securing portion disposed on said securing body and extending forwards from said securing body, said top edge securing portion being adapted for disposing on a top edge of the display and being coupled to a bottom end of said suspending cable of said suspending cable set, and
a bottom edge securing portion disposed on said securing body below said top edge securing portion and extending forwards from said securing body, said bottom edge securing portion being adapted for abutting against a bottom edge of the display; and
a color detector securing unit including
a plurality of guiding elements spaced apart from one another, disposed on said rear face of said securing body adjacent to said central through hole, and extending rearwards from said securing body, and
a securing seat disposed on said guiding elements such that said securing seat is movable forward, toward said securing body, and rearward, away from said securing body, said securing seat being adapted for securing the color detector such that the lens end of the color detector faces said central through hole.

8. The display inspection module as claimed in claim 7, further comprising a sliding element coupled slidably to said guiding rail of said guiding rail set, said top end of said suspending cable of said suspending cable set being coupled to said sliding element.

9. The display inspection tool as claimed in claim 8, comprising two of said sliding elements, said guiding rail set including two of said guiding rails that are spaced apart from each other, said suspending cable set including two of said suspending cables, wherein:
said securing body includes a connecting section, a pair of upper arm sections extending upwards from said connecting section and spaced apart from each other, and a lower arm section extending downwards from said connecting section;
said top edge securing portion includes a pair of seat parts, said seat parts being disposed respectively on top ends of said upper arm sections;
said bottom ends of said suspending cables are coupled respectively to said seat parts; and
said bottom edge securing portion is disposed on a bottom end of said lower arm section.

10. The display inspection module as claimed in claim 9, the top edge of the display being formed with a pair of notches that are spaced apart from each other, wherein each of said seat parts includes a seat plate extending forwards from said top end of the respective one of said upper arm sections, and a positioning block disposed on a bottom face of said seat plate, said positioning blocks of said seat parts being extendible into the notches in the top edge of the display, respectively.

11. The display inspection module as claimed in claim 10, wherein said bottom edge securing portion has a generally L-shaped lateral cross section, and includes a first plate section that extends in a top-bottom direction and a second plate section that extends forwards from a bottom end of said first plate section, said first plate section having a pivot point on a top end thereof that is coupled to said bottom end of said lower arm section, said second plate section abutting against the bottom edge of the display when said securing member is mounted on the display.

12. The display inspection module as claimed in claim 11, wherein:
each of said guiding elements is an elongate rod;
said securing seat has a ring shape, defines a central ring opening through which the color detector is to be extended, and is formed with a plurality of through holes extending in the front-rear direction and through which said guiding elements respectively extend so that said securing seat is movable forward, toward said securing body, and rearward, away from said securing body, along said guiding elements; and
said color detector securing unit further includes a plurality of first adjusting screws extending threadedly through said securing seat for abutting against said guiding elements, thereby limiting movement of said securing seat along said guiding elements.

13. The display inspection module as claimed in claim 12, wherein said color detector securing unit further includes a plurality of second adjusting screws extending threadedly through said securing seat for abutting against the color detector so as to secure the color detector in said securing seat.

14. A display inspecting method to be performed using a display inspection tool that has a color detector secured thereon, said display inspecting method comprising the steps of:
(a) extending respectively a pair of positioning blocks disposed on a top portion of the display inspection tool into a pair of notches formed in a top edge of a display;
(b) bringing a plate section, which extends forwards from a bottom portion of the display inspection tool, into abutment against a bottom edge of the display; and
(c) inspecting a display panel of the display using the color detector.

15. The display inspecting method as claimed in claim 14, wherein, in step (a), a front face of the display inspection tool faces the display panel of the display.

16. The display inspecting method as claimed in claim 15, wherein, in step (b), a lens end of the color detector is registered with a geometric center of the display panel of the display after the plate section is brought into abutment against the bottom edge of the display.
